(19) United States
(12) Patent Application Publication
(10) Pub. No.: US 2003/0157293 A1
(43) Pub. Date: Aug. 21, 2003

(54) Filled articles comprising blown fibers

(76) Inventor: Darren Scott Quinn, Goldsboro, NC (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/081,983

(22) Filed: Feb. 21, 2002

(51) Int. Cl. B32B 3/00; B32B 1/04; B32B 3/02

(52) U.S. Cl. 428/74; 428/68; 428/72; 428/220; 442/352

(57) ABSTRACT

The present invention relates to filled articles such as comforters, pillows, duvets, quilts, sleeping bags and the like which are filled with low denier per filament fibers having a curvilinear structure.

### BACKGROUND OF THE INVENTION

1. Field of the Invention

The present invention relates to filled articles such as comforters, pillows, duvets, quilts, sleeping bags and the like which are filled with low denier per filament fibers having a curvilinear structure.

2. Description of Related Art

Down is widely accepted as the premium filling material for high-end insulated bedding. Its luxurious feel, refluffability and exceptional warmth and softness make it the standard in the industry. Polyester batting has been made in an attempt to emulate this feel, but even the best fibers fall short in terms of tactile feel, since down is a loose fill, and fiber batts are by definition structured.

Attempts to create a blown fill have met with limited success. Typically, blow fiber is difficult to distribute evenly across the comforter shell during construction. In addition, blown fibers tend to clump during actual use, with these clumps being difficult to disentangle. This is especially true of mechanically crimped fibers such as those produced by the conventional stuffer box method. Such mechanically crimped fibers have a saw-tooth crimp structure with sharp nodes which act like Velcro®, and stick together. Thus, such fibers are more difficult to spread out initially, and tend to clump more during use. Clusters such as those disclosed in U.S. Pat. No. 4,618,531 have been tried in this end use but the success here has been hampered by the same problems as with blow fibers, i.e., difficulty in spreading and clumping. This is because these clusters according to the current state of the art have extraneous fibers protruding from the fiber balls and these fibers tend to entangle with the fibers of adjacent clusters. A further difficulty with all heretofore known blown, synthetic fills has been the propensity of the fillings to irreversibly clump during laundering.

### BRIEF SUMMARY OF THE INVENTION

The present invention overcomes the problems of the prior art by providing filled articles, and in particular comforters, in which fiberfill easily spreads during construction and in which the fibers can be easily refluffed during use.

Wash durability is also improved over other synthetic loose fill offerings. This is accomplished by the selection of a low denier fiber with a curvilinear crimp structure and a low fiber friction as the filling fiber.

Thus, in accordance with the present invention, there is provided a filled article with a blown, non-clustered fiber having a denier per filament of 3 or less, a curvilinear crimp structure and a staple pad friction of less than 0.260.

### BRIEF DESCRIPTION OF THE DRAWING(S)

FIG. 1 is an isometric view of a filled article according to the present invention.

### DETAILED DESCRIPTION OF THE INVENTION

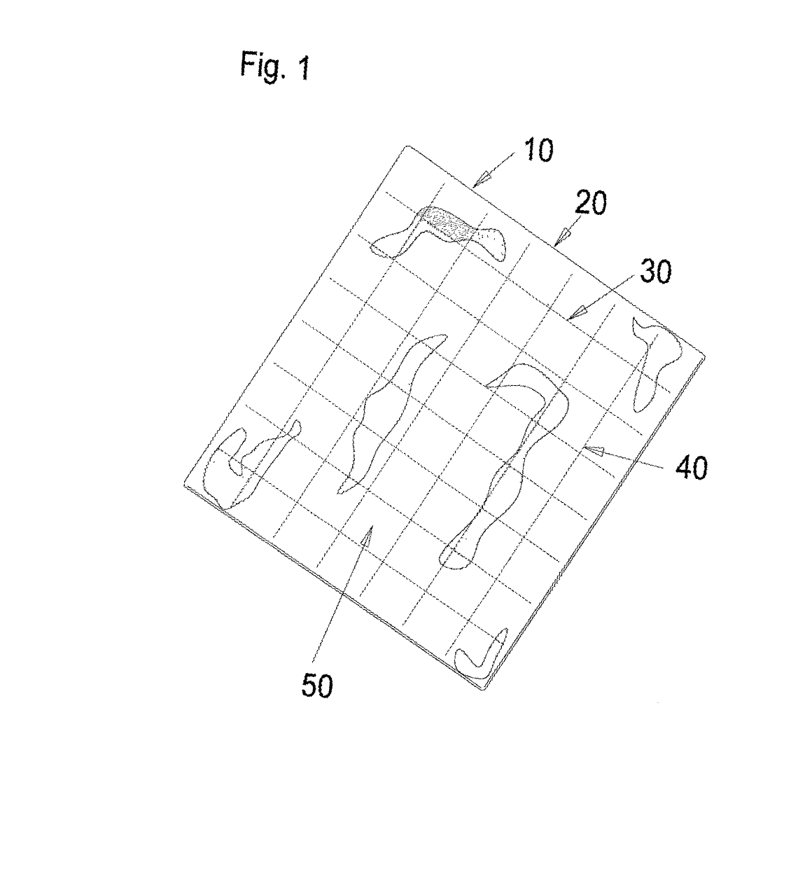

In accordance with the present invention, there is provided a filled article, such as a comforter 10 shown in FIG. 1, or a futon or cushion. The article comprises a blown, non-clustered fiber. By “non-clustered” is meant not having a randomly entangled, spherical shape. The fiber is a low denier per filament fiber, having a denier per filament of 3 or less. The fiber is super slickened, so that the when blown into a filled article, such as a comforter, the fibers slide over each other. This slickened quality is measured by staple pad friction, and the fiber of the present invention has a staple pad friction of less than 0.260. Also, the fiber of the present invention has by a curvilinear crimp structure. By “curvilinear” is meant that the synthetic filaments take up their helical configuration spontaneously during their formation and/or processing, as a result of differences between portions of the cross-sections of the filaments, as described in detail in U.S. Pat. No. 5,683,811.

While a comforter per the present invention may be any size, a substantially rectangular, queen size bed comforter with dimensions 88″×96″ (223.5 cm×244 cm) will be discussed in detail. Referring to FIG. 1, a comforter, 10, is formed by first opening and blowing fiber characterized as having a curvilinear crimp structure, a cut length less than 2.5″ (51 mm) and more preferably between 0.5″ (13 mm) and 1.5″ (38 mm) and having a staple pad friction of less than 0.260, and more preferably less than 0.225. Such opening is performed by mechanically separating the filaments one from another in a first stage process typically employing one or more multi-toothed rolls, referred to as opening or pre-opening. The opened fibers are then drawn into the suction of a blower from whence an appropriate amount is blown into a comforter shell positioned over the blowers discharge. This shell is formed by sewing the edges of two properly sized fabric sheets together along the periphery, 20, of the sheets leaving an unsewn opening sized to accommodate the discharge of the blower. Alternatively, the comforter shell can be prestitched into channels by sewing the two sheets together in appropriately spaced, parallel lines 30, in addition to the edge stitching while leaving one end perpendicular to the parallel stitching left unsewn. In this embodiment, the appropriate amount of filling would be blown into each channel. Following blowing, the opening of the comforter is sewn shut. At this point, the fiber is evenly distributed throughout the shell by redistributing the filling so as to force fiber from areas of an overabundance to areas lacking sufficient fill. This distribution can be performed in many ways either manually of with the assistance of a machine. After the fibers are essentially evenly distributed, the comforter is securely stretched into a frame designed to hold the comforter flat and taut. The framed comforter is then quilted by sewing the shell fabrics together, as shown at 30 and 40 in FIG. 1. The quilting pattern may be in any design provided the stitching forms hollow pockets or cells, 50, between the shell fabrics essentially bounded on all sides by the stitching with each cell containing an appropriate amount of the filling fiber. Such quilting thus effectively locks the filling material into a general region of the comforter.

As is illustrated by the following example, a comforter provided by this invention offers improvements in constructability due to the ease with which the fill can be distributed within the comforter shell. In addition and perhaps more importantly, the comforter so produced offers beneficial advantages in that the fill can be easily redistributed during actual use

### TEST METHODS

The parameters mentioned herein are standard parameters and are mentioned in the art referenced herein, as are methods for measuring them. Since methods can vary, especially for measuring bulk, methods used herein are summarized briefly.

Fiber Properties

Properties of the fibers are mostly measured essentially as described by Tolliver in U.S. Pat. No. 3,772,137, and as referenced by Hernandez in U.S. Pat. No. 5,458,971. BL1 was the measurement made at 0.001 psi in Tolliver, and BL2 was the measurement made at 0.2 psi in Tolliver. These measurements are the TBRM (Total Bulk Response Method), as described in Tolliver.

Crimp Frequency (CF)

These measurements were made as described by Tolliver in U.S. Pat. No. 3,772,137. In the Tables that follow in the Examples hereinafter the measurements are given in crimps per inch.

Staple Pad Friction

Friction is measured by the SPF (Staple Pad Friction) method, as described hereinafter. As used herein, a staple pad of the fibers whose friction is to be measured is sandwiched between a weight on top of the staple pad, and a base that is underneath the staple pad and is mounted on the lower crosshead of an Instron 1122 machine (product of Instron Engineering Corp., Canton, Mass.).

A staple pad is prepared by carding the staple fibers (using a SACO-Lowell roller top card) to form a batt which is cut into sections, that are 4.0 inches in length and 2.5 inches wide, with the fibers oriented in the length dimension of the batt. Enough sections are stacked up so the staple pad weighs 1.5 gm. The weight on top of the staple pad is of length (L) 1.88 inches, width (W) 1.52 inches, and height (H) 1.46 inches, and weighs 496 gm. The surfaces of the weight and of the base that contact the staple pad are covered with Emery cloth (grit being in 220-240 range), so that it is the Emery cloth that makes contact with the surfaces of the staple pad. The staple pad is placed on the base. The weight is placed on the middle of the pad. A nylon monofil line is attached to one of the smaller vertical (W×H) faces of the weight and passed around a small pulley up to the upper crosshead of the Instron, making a 90 degree wrap angle around the pulley.

A computer interfaced to the Instron is given a signal to start the test. The lower crosshead of the Instron is moved down at a speed of 12.5 in/min. The staple pad, the weight and the pulley are also moved down with the base, which is mounted on the lower crosshead. Tension increases in the nylon monofil line as it is stretched between the weight, which is moving down, and the upper crosshead, which remains stationary. Tension is applied to the weight in a horizontal direction, which is the direction of orientation of the fibers in the staple pad. Initially, there is little or no movement within the staple pad. The force applied to the upper crosshead of the Instron is monitored by a load cell and increases to a threshold level, when the fibers in the pad start moving past each other. (Because of the Emery cloth at the interfaces with the staple pad, there is little relative motion at these interfaces; essentially any motion results from fibers within the staple pad moving past each other.) The threshold force level indicates what is required to overcome the fiber-to-fiber static friction and is recorded.

The coefficient of friction is determined by dividing the measured threshold force by the 496 gm weight. Eight values are used to compute the average SPF. These eight values are obtained by making four determinations on each of two staple pad samples.

Crimp Take-Up (CTU)

Crimp take-up is measured by the rope crimp take up method as described below.

Rope Crimp Take-Up

A rope of known denier at least 1.5 meters in length is prepared for measurement by placing a knot in both ends. The resulting sample is subjected to a load of 125 mg/den. Two metal clips are placed across the extended rope at a distance apart of exactly 100 centimeters. The two ends of the rope are cut off within 1-2 inches beyond the clips. The resulting cut band is hung vertically and the recovered crimped length between the clips is measured to the nearest 0.5 centimeters. Crimp take-up is calculated using the following equation

% CTU=A−B/A×100

where A is the extended length, 100 centimeters, B is the retracted crimp length in centimeters.

Clo Units

The insulation of a textile system can be expressed in terms of a clo unit. The unit clo is normally used for expressing clothing insulation since it is related to clothing commonly worn, but may be used for other textiles. The value for 1 clo is defined by first considering that the resting metabolic heat production of an average man is about 50 kcal/m^{2·}h. Approximately 25% of this heat is lost via the respiratory system and by diffusion of moisture through the skin. Therefore, 38 kcal/m^{2·}h remains lost through the clothing via radiation, conduction, and convection. The temperature difference across the clothing is equal to the difference between the mean skin temperature (Tₛ) and the ambient air temperature (Tₐ), assuming the mean radiant temperature of the surroundings is equal to the air temperature. Consequently, a clothed person with a comfortable skin temperature of 33.3° C. (92° F.) in a comfortable environment at 21° C. (70° F.), has a 12° C. temperature gradient across which 38 kcal/m^{2·}h is transferred. A heat transfer coefficient of 0.32° C. m²·h/kcal is calculated by dividing the temperature difference by the heat flow (i.e., 12/38). About 0.14 of the 0.32 total is contributed by the surrounding air layer, so 0.18 is contributed by the clothing alone. Thus 1 clo of insulation is equal to 0.18 m^{2·}° Ch/kcal.

### EXAMPLE

A comforter according to the present invention was prepared by first opening the baled fiber described in Table 1, Item A, through a Crompton and Knowles opener/blower. In this machinery, the compacted fibers were separated one from another in a first stage process typically referred to as opening or pre-opening. The opened fibers were then drawn into the suction of a blower from whence they were blown into a receiving receptacle held over the blower's discharge with the receiving receptacle typically taking the form of a pillow tick or comforter shell. In this Example, 40 oz. of the fiber was blown into the open end of an 88″ by 96″ comforter shell constructed of a 100% cotton, 312 thread count sateen fabric. Following blowing, the open end of the comforter was sewn shut. At this point, the closed comforter was spread across a flat table and the fiber was evenly distributed throughout the shell by manually redistributing the filling so as to force fiber from areas of an overabundance to areas lacking sufficient fill. Such redistribution was accomplished with the aid of a cylindrical rod applied as needed against the outside of the comforter shell. It was observed during this process that the fibers were more easily distributed than the fillings described in comparative Examples 1, 2, & 3 below. After the fibers were essentially evenly distributed, the comforter was transferred to a light table constructed such that a light source from below shines upward through the comforter and reveals any areas barren of fiber. The fibers were then finely adjusted to assure that they were evenly distributed throughout the comforter by applying pressure through the comforter shell as needed to propel fibers from areas of surplus to areas having insufficient fill. Following this adjustment, the comforter was securely stretched into a frame designed to hold the comforter flat and taut. The framed comforter was then passed through an automatic quilting machine which stitched through both sides of the comforter in a pattern to yield sewn cells with approximate 12″ by 12″ dimensions thus effectively locking the filling material into a general region of the comforter.

TABLE 1

| | Denier per | Crimp | Cut Length | Crimp per | | Staple pad | Initial bulk, | Support Bulk, |
|---|---|---|---|---|---|---|---|---|
| Item | filament (Dtex) | Type * | in. (mm) | in. (C/cm) | CTU | friction | BL-1 in. (cm) | BL-2 In. (cm) |
| A | 2.0 (2.2) | C | 1.26 (32) | 8.14 (3.2) | >28 | 0.187 | 5.29 (13.44) | 0.34 (.86) |
| B | 6.5 (7.2) | C | 1.125 (28) | Unknown | >38 | 0.245 | 5.70 | 0.43 |
| C | 7 (7.7) | C | 1.26 (32) | 3.7 (1.46) | unknown | 0.284 | 5.90 | 0.61 |
| D | 1.1 (1.2) | M | 1.42 | 13.69 (34.8) | unknown | Unmeasurable | unmeasurable | unmeasurable |

* Crimp Type: C = Curvilinear, M = Mechanical “Saw tooth”

### Comparative Example 1

A comforter was constructed essentially as described in Example 1 with the exception that the fiber used was that shown in Table 1, item B.

### Comparative Example 2

A comforter was constructed essentially as described in example 1 with the exception that the fiber used was that shown in Table 1, item C.

### Comparative Example 3

A comforter was constructed essentially as described in Example 1 with the exception that the fiber used was that shown in Table 1, item D which is the commercially available Primaloft® comforter marketed by Albany International, Inc.

Following construction, comforters produced per Example 1 and comparative Examples 1, 2, and 3 were evaluated for warmth, tactile aesthetics and wash durability. Warmth data is shown in Table 3.

TABLE 3

| | | | Thermal |
|---|---|---|---|
| | Avg. Fill | Avg. | Conductivity |
| | Density | thickness | per unit |
| | oz/yd² | at 0.002 | weight |
| Item | (g/m²⁾ | psi load | Clo/oz/yd² |
| A Ex. 1 | 7.22 (245) | 1.3 (3.3) | 0.247 |
| B Comp 1 | 5.69 (193) | 1.20 (3.0) | 0.196 |
| C Comp 2 | 6.18 (210) | 1.26 (3.2) | 0.197 |
| D Comp 3 | 7.29 (247) | 1.3 (3.3) | 0.271 |

As can be seen, the thermal conductivity of Example 1 is superior to that of the other curvilinear crimp items and rivals that of comparative Example 3 despite the higher denier and thus lower radiant shielding of example one.

Regarding tactile aesthetics, the comforter of Example 1 was found to respond much more similarly to the preferred down comforters in that the filling was more free to move within each quilted comforter cell vs. the comparative examples. As is typical for down comforters and other loose fill comforters and contrary to the performance observed with typical synthetic batting comforters, drapability of Example 1 and comparative Examples 1, 2, and 3 as determined by any conventional method is primarily set by the stiffness of the shell material. This property is due to the proclivity of the loose fill to gravitate toward the lower portion of each quilted cell as the comforter is allowed to hang vertically over the edge of a bed or other horizontal surface thus leaving only shell fabric at the comforter's point of inflection. The comforter of example 1 was found to be capable of having it's fill material redistributed from these lower cell portions to once again evenly fill the said cells by merely applying a gentle shaking action to the edge of the comforter adjacent to the maldistributed cells. By comparison, comparative Examples 1, 2, and 3 each required a vigorous shaking of the comforter cells with occasional manual manipulation of the fill through the shell.

After being subjected to 3 laundry cycles in a commercial, front loading washing machine using Tide powder as a detergent with subsequent drying between each cycle in a commercial electric clothes dryer, the comforters of example 1 and comparative Examples 1, 2, and 3 were observed for wash durability. The qualitative results are shown in Table 3.

TABLE 3

| | | | Rank | |
|---|---|---|---|---|
| | | | relative | |
| | Comforter | | to others | Pass/Fail |
| Item | observation | Fill observation | in test | rating |
| A Example 1 | Slightly lumpy, | Slightly | 1 | Pass |
| | Fill easily | entangled | | |
| | respread | | | |
| B Comp 1 | Lumpy, filling | Cluster like | 2 | Fail |
| | respreadable but | entanglements. | | |
| | comforter looses | | | |
| | loft during | | | |
| | respreading | | | |
| C Comp 2 | Lumpy, filling | Matted with | 3 | Fail |
| | respreadable but | large cluster | | |
| | comforter looses | like | | |
| | loft during | entanglements | | |
| | respreading | | | |
| D Comp 3 | Lumpy, Difficult | Fiber entangled | 4 | Fail |
| | to respread | into twisted | | |
| | | structures | | |

What is claimed is

1. A filled article comprising a non-clustered, blown fiber having a denier per filament of 3 or less, characterized by a curvilinear crimp structure and a staple pad friction less than 0.260.

2. The filled article of claim 1, wherein the fibers have a cut length in the range of 0.5″ to 2.0″

3. The filled article of claim 1, wherein the denier per filament is 2.5.

4. The filled article of claim 2, wherein the denier per filament is 2.5.

5. The filled article of claim 4, wherein the filled article is a comforter.
